(19) United States
(12) Patent Application Publication
(10) Pub. No.: US 2016/0149168 A1
(43) Pub. Date: May 26, 2016

(54) Receptacle Device, Battery, and Motor Vehicle

(71) Applicants: ROBERT BOSCH GMBH, Stuttgart (DE); SAMSUNG SDI CO., LTD., Yongin-si, Gyeonggi-do (KR)

(72) Inventors: Stefan Butzmann, Schalksmühle (DE); Holger Fink, Stuttgart (DE); Hans Partes, Asperg (DE)

(21) Appl. No.: 14/903,334

(22) PCT Filed: May 20, 2014
(86) PCT No.: PCT/EP2014/060283

§ 371 Date: Jan. 7, 2016

(30) Foreign Application Priority Data
Jul. 11, 2013 (DE) 10 2013 213 551.3

(51) Int. Cl. H01M 2/02; H01M 2/06; H01M 10/48; H01M 10/0525; H01M 2/04

(52) U.S. Cl. CPC H01M 2/024; H01M 10/0525; H01M 2/0285; H01M 2/0473; H01M 2/0486; H01M 10/48; H01M 10/486; H01M 2/06; H01M 2220/20

(57) ABSTRACT

A receptacle device for at least one electrode assembly includes a metal housing and a metal. The housing and the cover each are a prismatic shape with a base surface, side walls and an aperture. The aperture lies opposite the base surface. The base surface of the cover is at least one wall thickness of the side walls of the cover larger than the base surface of the housing. The receptacle device further includes a measuring device configured to measure at least one measurement variable. The measuring device is arranged on an edge of the aperture of the housing or of the cover. The measurement variable is a value for at least one of a voltage, a current strength, and a temperature.

The present invention relates to a receptacle device for an electrode assembly of a battery cell, a battery and a motor vehicle. The battery cell is preferably a lithium ion battery.

### PRIOR ART

Receptacle devices for electrodes of a battery cell are used in the form of so-called hard shells (=hard cases). Such receptacle devices can comprise a housing (=can) that is embodied from metal and has a prismatic shape with a base surface, side walls and an aperture that lies opposite the base surface. Battery cells in prismatic housings are also described as prismatic battery cells.

Hard cases comprise a cover (=cap plate) that matches the housing. The cover is welded to the housing during the production process, by way of example by means of a laser welding method. The wall thickness of the side walls of the housing is usually between 0.4 and 1.5 mm, the cover is generally 0.6 to 2 mm thick.

In hard cases, the electrodes of the battery cell are embodied as an electrode winding, wherein the electrodes are separated by a separator that is arranged between the electrodes. The electrode winding is embodied so that a part of the anode protrudes on one side and a part of the cathode protrudes on the other side and the protruding parts are used as connecting lugs for current collectors. The current collectors are connected to terminals that are guided in an insulated manner through apertures in the cover.

Hard cases provide good protection against external influences, such as moisture, impacts, penetrations or air, to which in particular but not only lithium ion cells are sensitive.

As an alternative to hard cases, battery cells are known whose electrodes are encased by a coated metal film. Battery cells having electrodes that are encased by a metal film are also described as pouch cells. The electrodes can be an electrode stack of electrode pairs or an electrode winding. In contrast to hard cases, pouch cells render it possible to fill a larger proportion of the volume required by the battery cell with an active material.

The patent application (Offenlegungsschrift) DE 10 2008 010 837 A1 and the international application WO 2009/103522 A1 that claims the priority of the known patent application (Offenlegungsschrift) describe a lithium ion high voltage battery having a battery housing. The battery housing comprises a housing lower part and a housing upper part that can be placed on the battery lower part in such a manner as to protrude beyond said battery lower part. A seal can be arranged between the housing lower part and the housing upper part, said seal sealing the housing and being used to fasten the housing parts to one another. A high voltage plug that is arranged on an electronic component and protrudes outwards through a cut-out in the housing lower part renders it possible for the battery to draw off or supply energy in a controlled manner. The electronic component is used to monitor the cell voltage, to control the battery and/or as a protective element.

Heavy duty battery systems for generating alternating voltage often comprise a power inverter, also described as an inverter, having power switches that are arranged in series on parallel current branches. If the inverter of such a battery system comprises three or more parallel current paths, the battery system can be embodied directly for supplying energy to a machine that is suitable for generating a torque so as to drive hybrid vehicles and electric vehicles. Such battery systems are also described as traction battery systems or in short as traction batteries.

One part of the energy that is stored in the battery and is stored in the parasitic inductance is converted in the power switches during switching procedures into heat. This is counteracted by means of a cooling procedure.

### DISCLOSURE OF THE INVENTION

In accordance with the invention, a receptacle device, a battery and a motor vehicle are provided. The receptacle device is suitable for at least one electrode assembly, wherein the receptacle device comprises a metal housing and a cover, in each case of a prismatic shape with a base surface, side walls and an aperture that lies opposite the base surface. The base surface of the cover is at least one wall thickness of the side walls of the housing larger than the base surface of the housing. The receptacle device is characterized by virtue of the fact that a device for measuring at least one measurement variable is arranged on an edge of the aperture of the housing or of the cover, wherein the measurement variable is a value for a voltage and/or a current strength and/or a temperature.

By virtue of the corresponding prismatic shape of the cover and the housing and also the relatively larger base surface of the cover with respect to the base surface of the housing, it is possible to place the cover on the housing in such a manner that said cover protrudes beyond said housing. After an electrode assembly has been arranged in the housing, it is thus possible to seal the housing easily by means of placing the cover and subsequently sealing the arrangement, wherein terminals of the electrode assembly can be guided outwards between the cover and housing on both sides of the measuring device in an insulated manner so that it is easily possible to connect the measuring device to the terminals.

In one embodiment, cut-outs can be arranged on the edge on both sides of the measuring device in order to be able to guide the terminals of the electrode assembly outwards even more easily.

It is possible to arrange in the cut-outs an insulation that is suitable for insulating in an electrical manner the terminals, which are guided outwards through the cut-outs, from the housing and/or the cover. The terminals can then be easily insulated with respect to the receptacle device.

The battery provided in accordance with the invention comprises at least one electrode assembly in a receptacle device that is provided in accordance with the invention. The housing is sealed by means of the cover and the terminals of the electrode assembly are guided outwards in an insulated manner between the cover and the housing.

In one embodiment of the battery, each electrode of the electrode assembly can comprise a flap strip (=tab), wherein in each case the flap strips of the electrodes that have the same polarity can be connected to one terminal. This is a particularly easy way of producing terminals of the battery.

As an alternative or in addition thereto, the electrode assembly can be wrapped in a multi-layer packaging film. The packaging film is used in an advantageous manner as a barrier layer.

The housing can be connected to the cover by means of a laser welding method or using Nano Molding Technology “NMT”. These are easy and effective welding methods.

Furthermore, the sealing arrangement can comprise a sealing flange that comprises solid metal glass and/or a metal alloy. The sealing flange renders it possible to use welding methods that operate at a comparatively low power.

Furthermore, the sealing arrangement can comprise a paste, wherein the paste is a ceramic paste or a glass paste. This is an alternative, easy and effective welding method.

The motor vehicle proposed in accordance with the invention comprises at least one battery that is proposed in accordance with the invention.

It is preferred that the electrode assembly comprises electrodes of a lithium ion battery cell.

Advantageous further developments of the invention are disclosed in the subordinate claims and described in the description.

### DRAWINGS

Exemplary embodiments of the invention are further explained with reference to the drawings and the description hereinunder, in which:

FIG. 1 illustrates a pouch cell in accordance with the prior art,

FIG. 2 illustrates a prismatic cell in accordance with the prior art,

FIG. 3 illustrates a housing of a prismatic cell in accordance with the prior art,

FIG. 4 illustrates a cover of a prismatic cell in accordance with the prior art,

FIG. 5 illustrates the cover of a prismatic cell in accordance with the prior art with terminals and current collectors,

FIG. 6 illustrates an electrode stack in accordance with the prior art,

FIG. 7 illustrates an exemplary embodiment of the housing of the receptacle device in accordance with the invention with an electrode stack,

FIG. 8 illustrates an exemplary embodiment of the housing of the receptacle device in accordance with the invention with an electrode winding, and

FIG. 9 illustrates the exemplary embodiment of the housing of the receptacle device in accordance with the invention with the cover placed thereon in an exemplary manner.

### EMBODIMENTS OF THE INVENTION

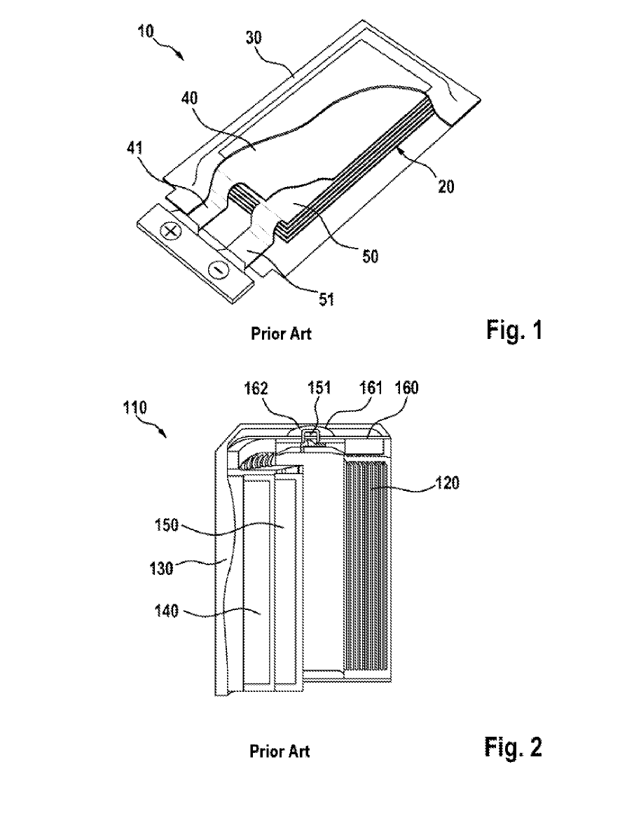

FIG. 1 illustrates an electrode assembly 10 in accordance with the prior art in the form of an electrode stack 20 that is packaged in a multi-layer manner in a metal film 30. The electrode stack 20 comprises anode films and cathode films. Each cathode film and each anode film comprises a flap strip (=tab) 41, 51 that is not insulated. Tabs 41, 51 that have the same polarity are connected to terminals of the electrode stack.

FIG. 2 illustrates an electrode assembly 110 in accordance with the prior art in the form of an electrode winding 120, that is arranged in a housing 130 having a cover 160. The electrode winding 120 comprises an anode film 150, a cathode film 140 and a separate film that is arranged between the anode 150 and the cathode 140. The anode 150 and the cathode 150 are connected by way of current collectors to a negative terminal 151 or to the housing 130. An aperture 161 for the negative terminal 151 is provided in the cover, wherein a sealing flange 162 insulates the cover 160 with respect to the negative terminal 151. Furthermore, an aperture for a safety valve is provided in the cover.

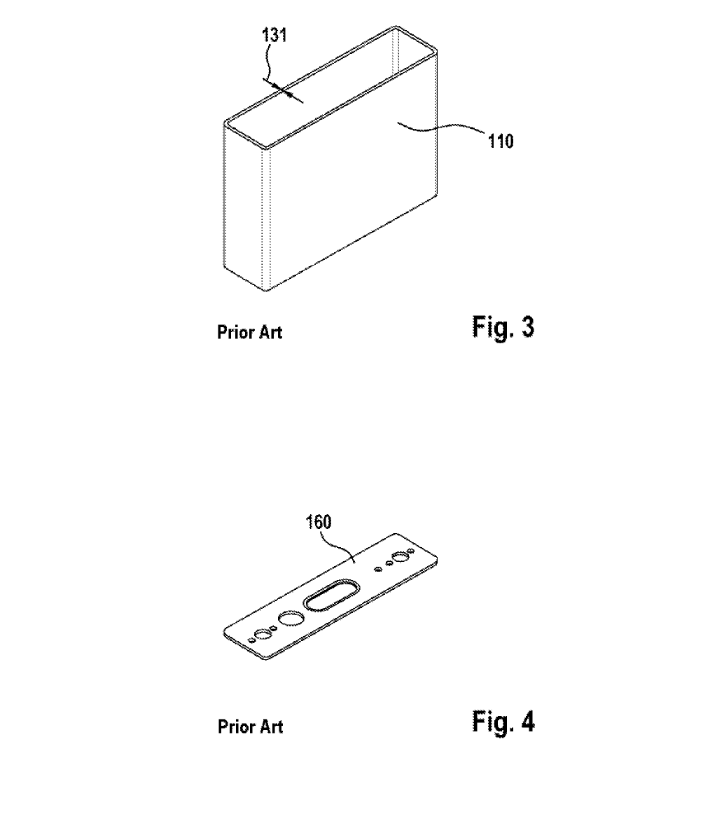

FIG. 3 illustrates a housing of a prismatic cell in accordance with the prior art. Such a housing 130 is also described as a “can” and is embodied from metal. It has a prismatic shape and in the illustrated example is rectangular with rounded corners. An aperture is provided opposite a base surface, said aperture being formed by upper edges of said walls of a wall thickness 131, wherein the lower edges of said side walls define the base surface.

FIG. 4 illustrates a cover 160 of a prismatic cell in accordance with the prior art having an aperture for a valve 162 by way of which it is possible to discharge any pressure that builds up in the receptacle device if a limit value is exceeded. Further apertures are used for the purpose of guiding through the electrode terminals.

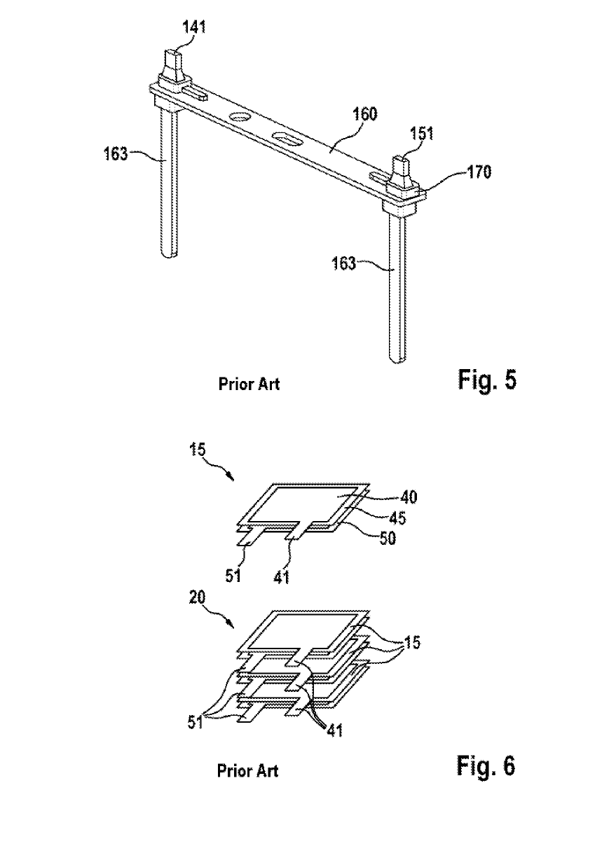

FIG. 5 illustrates the cover 160 of a prismatic cell in accordance with the prior art with terminals 141, 151. The terminals 141, 151 are separated in an electrical manner from the cover by means of insulating seals 170 and are connected in an electrical manner to current collectors 163. The current collectors for their part can be connected to the electrodes 140, 150 of an electrode winding 110.

FIG. 6 illustrates an electrode stack in accordance with the prior art in detail. The electrode stack 20 comprises individual cells 15 which for their part comprise in each case one anode film, one cathode film and a separator film 45 that is arranged between the anode 50 and the cathode 40. Each cathode film and each anode film comprises a non-insulating flap strip (=tab) 41, 51. Tabs 41, 51 that have the same polarity are connected to terminals of the electrode stack.

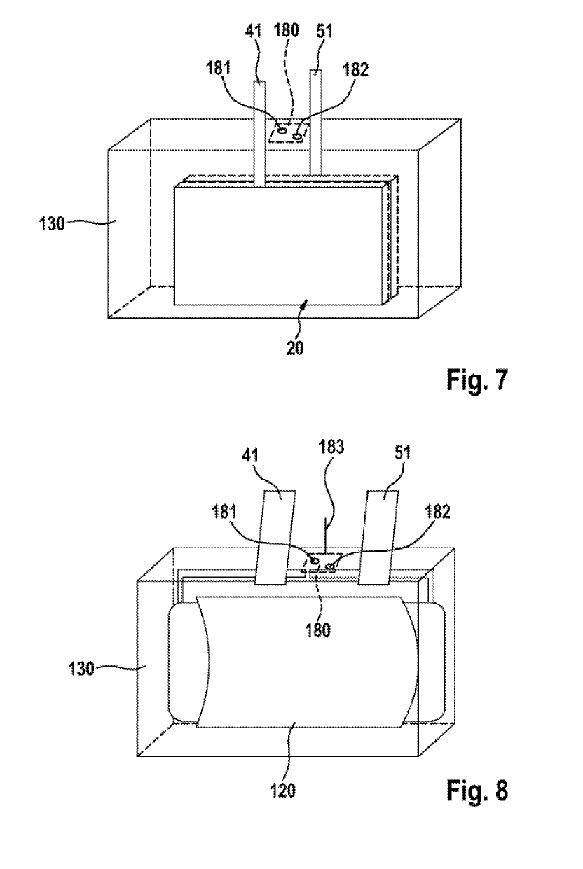

FIG. 7 illustrates an exemplary embodiment of the housing 130 of the receptacle device in accordance with the invention with an electrode stack 20 in the housing 130. The housing 130 has the prismatic shape of a shoe box with a base surface, side walls that extend perpendicular with respect to the base surface and an aperture that is lying opposite the base surface. In the illustrated example, the base surface is larger than the side surfaces so that electrodes that are of a size that corresponds to the base surface can be stacked therein. The stacking direction is then parallel to the normal of the base surface. It is also possible to provide a configuration that has parallel side surfaces so that an electrode stack of electrodes whose size corresponds to the parallel side walls can be inserted into the housing in the stacking direction perpendicular to the normal of the base surface.

The housing 130 comprises on or near to the edge of the aperture a device 180 for measuring at least one measuring variable, by way of example a cell voltage, which is connected in an electrical manner, to tabs 41, 51 of the electrodes of the electrode stack 20 by way of contacts 181, 182, said connection being formed by way of example by means of a soldering method, possibly using ultrasound, or welding or any other method. Other measurements for example of temperature and/or current strength are possible. The tabs 41, 51 are guided outwards beyond the edge of the aperture of the housing 130 as close as possible to and on both sides of the device 180. The housing comprises an insulating coating (not illustrated) in the region in which the tabs 41, are guided outwards. As an alternative or in addition thereto, the tabs 41, 51 are coated in an insulating manner. Likewise not illustrated is a signal connection by way of which it is possible to communicate a measurement value that is determined by the device 180.

FIG. 8 illustrates an exemplary embodiment of the housing 130 of the receptacle device in accordance with the invention with an electrode winding 120 in the housing 130. The housing 130 comprises on the edge of the aperture of the housing 130 the device 180 for measuring at least one measurement variable. Long tabs 41, 51 are connected to the connecting lugs of the electrodes of the electrode winding 120. Likewise, the tabs 41, 51 are guided outwards beyond the edge of the aperture of the housing 130 as close as possible to and on both sides of the device 180 at sites that are coated in an insulating manner. As an alternative or in addition thereto, the tabs 41, 51 are coated in an insulating manner. Other devices for measuring the temperature and/or current strength are also possible. It is possible by way of a signal connection 183 to communicate a measurement variable that is determined by the device 180 to a higher ranking control unit, not illustrated.

In the exemplary embodiments, the spacings of the contacts 181, 182 with respect to the tabs 41, 51 are very short and the spacing between the tabs 41, 51 is likewise short. The latter leads to a comparatively low level of parasitic inductance and consequently to fewer heat losses when using an inverter, for example in a motor vehicle.

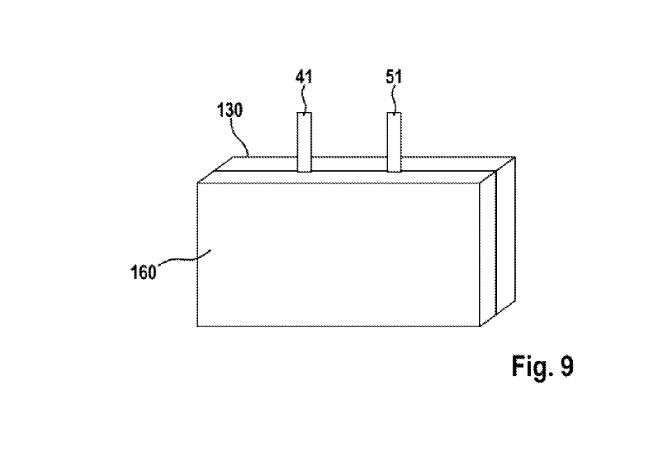

FIG. 9 illustrates the exemplary embodiment of the housing 130 of the receptacle device in accordance with the invention with the cover 160 placed thereon by way of example in such a manner that it extends beyond said housing. The tabs 41, 51 and the signal connection 183 are accessible from the outside. It is irrelevant whether the tabs 41, 51 are connected in an electrical manner to an electrode stack or to an electrode winding inside the receptacle device.

The receptacle device is permanently sealed. Said receptacle device can be sealed by way of example by means of connecting the cover 160 to the housing 130 by means of a laser welding method or using Nano Molding Technology “NMT”. The sealing arrangement of the housing 130 by means of the cover 160 can also comprise a sealing flange that comprises solid metal glass and/or a metal alloy. Or the receptacle device is sealed by means of a paste, wherein the paste is a ceramic paste or a glass paste.

The receptacle device can comprise at least one device that can be a safety device, an over-charge protective device or a valve for discharging gas.

One exemplary embodiment of the receptacle device in accordance with the invention for a battery cell comprises a housing and a cover. The housing has a prismatic shape with a base surface and an aperture that lies opposite the base surface. The cover is suitable for sealing the aperture. The cover has a prismatic shape, wherein the size of the base surface of the cover differs from the size of the base surface of the housing so that the cover can be crimped over the aperture in a positive locking manner.

1. A receptacle device for at least one electrode assembly, comprising:
a metal housing and a metal cover, the housing and the cover each being a prismatic shape with a base surface, side walls and an aperture opposite the base surface; and
a measuring device configured to measure at least one measurement variable,
wherein the base surface of the cover is at least one wall thickness of the side walls of the cover larger than the base surface of the housing,
wherein the measuring device is arranged on an edge of the aperture of the housing or of the cover, and
wherein the measurement variable is a value for at least one of a voltage, a current strength, and a temperature.

2. The receptacle device as claimed in claim 1, wherein cutouts are arranged on the edge of both sides of the measuring device and the terminals of the electrode assembly can are configured to be guided outwards through said cutouts.

3. The receptacle device as claimed in claim 2, wherein an electrical insulation is arranged in the cutouts, said electrical insulation configured to insulate in an electrical manner the terminals from at least one of the housing and the cover, said terminals being guided outwards through the cutouts.

4. A battery comprising:
at least one electrode assembly in a receptacle device, the receptacle device including:
a metal housing and a metal cover, the housing and the cover each being a prismatic shape with a base surface, side walls and an aperture opposite the base surface; and
a measuring device configured to measure at least one measurement variable,
wherein the base surface of the cover is at least one wall thickness of the side walls of the cover larger than the base surface of the housing,
wherein the measuring device is arranged on an edge of the aperture of the housing or of the cover,
wherein the measurement variable is a value for at least one of a voltage, a current strength, and a temperature, and
wherein the housing is sealed using the cover and terminals of the electrode assembly are guided outwards in an insulated manner between the cover and the housing.

5. The battery as claimed in claim 4, wherein the electrode assembly is an electrode stack and each electrode of the electrode assembly comprises a flap strip and in each case the flap strip of the electrodes that have the same polarity are connected to a terminal.

6. The battery as claimed in claim 4, wherein the electrode assembly is packaged in a multi-layer packaging film.

7. The battery as claimed in claim 4, wherein the housing is connected to the cover using a laser welding method or using Nano Molding Technology “NMT”.

8. The battery as claimed in claim 4, wherein the seal further includes a sealing flange having at least one of solid metal glass and a metal alloy.

9. The battery as claimed in claim 4, wherein the seal further includes a paste, the paste being a ceramic paste or a glass paste.

10. A motor vehicle comprising:
at least one battery including:
at least one electrode assembly in a receptacle device, the receptacle device having:
a metal housing and a metal cover, the housing and the cover each being a prismatic shape with a base surface, side walls and an aperture opposite the base surface; and
a measuring device configured to measure at least one measurement variable,
wherein the base surface of the cover is at least one wall thickness of the side walls of the cover larger than the base surface of the housing,
wherein the measuring device is arranged on an edge of the aperture of the housing or of the cover,
wherein the measurement variable is a value for at least one of a voltage, a current strength, and a temperature, and
wherein the housing is sealed using the cover and terminals of the electrode assembly are guided outwards in an insulated manner between the cover and the housing.
